(19) United States
(12) Patent Application Publication
(10) Pub. No.: US 2016/0056424 A1
(43) Pub. Date: Feb. 25, 2016

(54) COMPLIANT POLYMER SEALS FOR SODIUM BETA ENERGY STORAGE DEVICES AND PROCESS FOR SEALING SAME

(71) Applicants: Guosheng Li, Richland, WA (US); Kerry D. Meinhardt, Richland, WA (US); Xiaochuan Lu, Richland, WA (US); Jon Yong Kim, Richland, WA (US); Vincent L. Sprenkle, Richland, WA (US)

(72) Inventors: Guosheng Li, Richland, WA (US); Kerry D. Meinhardt, Richland, WA (US); Xiaochuan Lu, Richland, WA (US); Jon Yong Kim, Richland, WA (US); Vincent L. Sprenkle, Richland, WA (US)

(73) Assignee: BATTELLE MEMORIAL INSTITUTE, Richland, WA (US)

(21) Appl. No.: 14/464,356

(22) Filed: Aug. 20, 2014

(51) Int. Cl. H01M 2/08

(52) U.S. Cl. CPC H01M 2/08

(57) ABSTRACT

A new compliant polymer seal and process for sealing sodium conducting energy storage devices and batteries are disclosed. Compliant polymer seals become viscous at the operation temperature which seals cathode and anode chambers and other components together following assembly. Seals can accommodate thermal expansion mismatches between selected components during operation.

### STATEMENT REGARDING RIGHTS TO INVENTION MADE UNDER FEDERALLY-SPONSORED RESEARCH AND DEVELOPMENT

This invention was made with Government support under Contract DE-AC05-76RLO1830 awarded by the U.S. Department of Energy. The Government has certain rights in the invention.

### FIELD OF THE INVENTION

The present invention relates generally to seals for sodium batteries. More particularly, the invention relates to a compliant polymer seal suitable for sodium energy storage devices and a process for making and sealing same.

### BACKGROUND OF THE INVENTION

Planar type ZEBRA (p-ZEBRA) batteries are far superior to tubular type batteries in such areas as cell packaging, thermal control, and production simplicity for mass production. However, p-ZEBRA batteries have not yet been commercialized due to challenges associated with hermetic sealing of large cells. Various sealing technologies have been proposed including, e.g., glass and brazed metal and metal alloy seals. However, none of these sealing materials has yet been implemented due to limitations in sealing temperatures, atmospheres, and thermal expansion compatibility in larger cells and batteries. And, while polymers of various types have been considered for sealing ZEBRA batteries, polymers have not been used to date due to high temperatures (e.g., 300° C.) needed for optimum operation of ZEBRA batteries that render conventional polymers unsuitable. Corrosion of polymers also remains a major challenge for use of polymer seals from secondary electrolytes such as NaAlCl₄ on the cathode side of the battery and from molten sodium on the anode side of the battery as corrosion decreases battery longevity and capacity during operation. Further, leakage of air into the anode chamber from poor seals can oxidize molten sodium and result in cell failure. Accordingly, new seals and methods are needed for sealing large p-type ZEBRA batteries and other sodium-conducting batteries that function at lower temperatures that resist corrosion in operation, that enhance longevity, and that maintain performance over an extended period. The present invention addresses these needs.

### SUMMARY OF THE INVENTION

The present invention includes a process and a compliant polymer seal for sealing sodium-conducting energy storage devices including sodium-conducting batteries. The process may include introducing a compliant seal comprised of a selected polymer at an interface or junction positioned between one or more selected components of the energy storage device. The compliant seal becomes viscous at an operation temperature at or below about 250° C. that seals the interface or junction between the selected components and seals the interface or junction between the selected components in the energy storage device during operation.

Energy storage devices include, but are not limited to, e.g., sodium-conducting energy storage devices, sodium-conducting beta-alumina solid electrolyte (BASE) batteries, intermediate temperature (<200° C.) ZEBRA batteries, metal halide batteries, liquid sodium batteries, molten sodium batteries, sodium-sulfur (Na/S) batteries, and other energy storage devices.

The operation temperature may be selected between about 100° C. to about 250° C. In some applications, compliant seals seal the energy storage device at an operation temperature between about 100° C. to about 200° C. In some applications, compliant seals seal the energy storage device at an operation temperature between about 180° C. to about 250° C.

Compliant seals may include a polyethylene polymer.

Compliant polymer seals may include various molecular weights. Molecular weights are selected to provide the required match between components of the energy storage device and that provide the required seal during operation at the selected temperatures. No limitations are intended.

Compliant seals may be introduced or assembled in the energy storage device when the energy storage device is in the discharged or unenergized state prior to operation.

Compliant seals may include a modifier that when added modifies the viscosity of the compliant seals during operation of the device to be above or below the viscosity of the native polymer. Modifiers may include, but are not limited to, e.g., glasses, ceramics, epoxies, plastics, including combinations of these various materials. Viscosities of compliant polymers of the present invention are not limited. Viscosities are selected that provide sealing between components of the device during operation.

In some applications, compliant polymer seals may be coupled to or used in concert with secondary sealing materials or components to minimize or decrease infusion of oxygen and other oxidative gases into the anode and cathode chambers of the energy storage device that can degrade performance, or to minimize contact with compliant polymer seals that can degrade the seals during operation.

In some applications, compliant polymer seals may be encapsulated in, or coated with, materials such as polytetrafluoroethylene (PTFE), epoxies, glasses, metals, ceramics, plastics, silicones, and combinations of these materials to enhance the lifetime of the polymer seals.

In some applications, compliant polymer seals may be enclosed in or surrounded by an inert gas such as nitrogen during operation to enhance the lifetime of the polymer seals.

Compliant seals may be configured to seal the energy storage device at a temperature above the glass transition temperature (T_{g}) of the polymer.

In some applications, compliant polymer seals may be positioned between a ceramic support that houses the cathode and anode chambers and the metal enclosure or metal casing that encloses the cathode and anode chambers that seal the respective chambers.

Cathode and anode chambers and enclosures may be constructed of or include selected materials including, e.g., metals, metal alloys, ceramics, and combinations of these various materials. Metals are not limited. Metal alloys may include, but are not limited to, e.g., stainless steels, coated stainless steels, Zircalloy®, Hastelloy®, and other metal alloys. Ceramics may include, but are not limited to, e.g., alumina and zirconia, conducting ceramics and insulating ceramics. Other materials may also be selected. No limitations are intended.

In some applications, the compliant polymer seal may be positioned between a cathode chamber and an anode chamber on respective sides of a sodium-conducting beta-alumina solid electrolyte.

In various applications, compliant polymer seals may be positioned, e.g., at the entrance to or exit from the anode and cathode chambers, between the BASE and metal enclosures that enclose the cathode and anode chambers, and/or channels that proceed to or lead from the cathode and anode chambers. No limitations are intended.

In some applications, compliant polymer seals may be positioned between the BASE and the cathode chamber to seal the cathode chamber that contains the cathode electrolyte (e.g., NaAlCl₄) during operation.

In some applications, compliant polymer seals may be positioned between the BASE and the anode chamber to seal the anode chamber that contains molten sodium during operation.

Compliant polymer seals are configured to accommodate thermal expansion mismatches between components in the energy storage device. Compliant polymer seals are also compatible with materials deployed in the energy storage devices including, but not limited to, anode electrolytes, cathode electrolytes, molten sodium, molten NaAlCl₄, BASE materials, metals, metal alloys, ceramics, glasses, including combinations of these various materials.

Compliant seals of the present invention decrease degradation in cell performance over time in sodium-conducting energy storage devices at the operation temperature. Performance degradation may be assessed by various performance measures including, but not limited to, e.g., capacity, energy efficiency, potential, state-of-charge (SoC), including combinations of these various measures.

In some applications, energy storage devices that include the compliant seals may exhibit a performance degradation of less than about 5% on average over at least 250 charge-discharge cycles at a discharge rate of 25 mW/cm² at selected operation temperatures compared with energy storage devices that do not include the compliant seals.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 shows an expanded view of a p-type ZEBRA battery sealed with compliant polymer seals of the present invention.

FIG. 2 shows another ZEBRA battery sealed with compliant polymer seals of the present invention.

FIG. 3 plots capacity as a function of cycle number for the battery of FIG. 1.

FIG. 4 plots energy efficiency as a function of cycle number for the battery of FIG. 1.

FIG. 5 plots voltage as a function of state-of-charge for the battery of FIG. 1.

### DETAILED DESCRIPTION

A method for sealing sodium-conducting energy storage devices with compliant polymer seals is detailed that allows operation at low temperatures. In the following description, embodiments of the present invention are shown and described by way of illustration of the best mode contemplated for carrying out the invention. It will be clear that the invention is susceptible of various modifications and alternative constructions. It should be understood that there is no intention to limit the invention to the specific forms disclosed, but, on the contrary, the invention is intended to cover all modifications, alternative constructions, and equivalents falling within the spirit and scope of the invention as defined in the claims. Therefore the description should be seen as illustrative and not limiting.

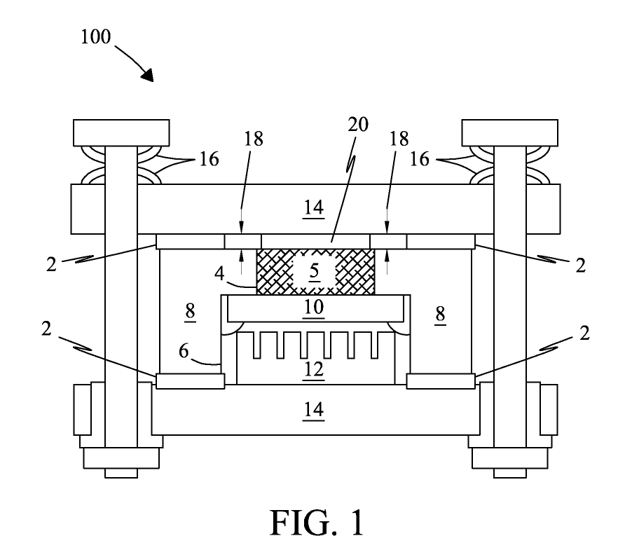

FIG. 1 shows an exemplary ZEBRA battery 100 of a selected cell design sealed with compliant polymer seals 2 of the present invention. Active area of ZEBRA device 100 is not limited. Device 100 may include a cathode chamber 4 that contains a cathode 5 and an anode chamber 6 that contains an anode (not shown). In the instant embodiment, cathode chamber 4 and anode chamber 6 may be machined into a support 8. Support 8 may be constructed of selected ceramics such as a-alumina, high-temperature refractory ceramics such as zirconia, or other suitable structural materials. No limitations are intended. In the instant embodiment, ceramic support 8 may be in the shape of an annular ring, but shapes are not intended to be limited. A solid electrolyte 10, e.g., a β″-alumina solid electrolyte (BASE) may be installed between cathode chamber 4 and anode chamber 6 to deliver sodium (Na⁺) between cathode 5 and the anode positioned in anode chamber 6 during operation. BASE 10 may be glass-sealed to ceramic support 8. Anode chamber 6 may include an anode shim 12 to facilitate accumulation of sodium metal formed at the anode at the surface of BASE 10 in anode chamber 6 during operation. In the figure, cathode chamber 4 and anode chamber 6 may each be enclosed in a cell case (casing) 14 constructed of, e.g., a metal, a metal alloy, or another suitable material. Cell casing 14 above cathode chamber 4 and below anode chamber 6 may be held in position with a compression device or component 16 such as a compression spring or other compression device. However, no limitations are intended.

In the figure, a compliant polymer seal 2 of the present invention is shown positioned at a junction 18 between ceramic support 8 and cathode case 14 on the cathode side of battery 100 which seals cathode chamber 4. Another compliant seal 2 may be positioned at a junction 18 between ceramic support 8 and anode case 14 on the anode side of battery 100 which seals anode chamber 6. However, number and location of compliant polymer seals is not limited. For example, compliant polymer seals 2 may be positioned between different components or at selected locations and junctions.

Compliant polymer seals 2 of the present invention may be constructed of various and selected polymers. Polymers may be selected that have a decomposition temperature above the operating temperature of the battery or device. In some embodiments, compliant polymer seals may be constructed of polyethylene (PE). No limitations are intended.

In various embodiments, a secondary material 20 may be installed in battery 100 in concert with compliant seals 2 such as an electrical (isolator) insulation material or a secondary sealing material. For example, electrical insulator materials may be added to provide electrical isolation or separation, e.g., between cathode chamber 4 and anode chamber 6. Secondary sealing materials may be added to prevent or minimize penetration or infusion of oxygen and other oxidative gases, aggressive chemical electrolytes, or other chemical components that can degrade compliant polymer seals 2 or can otherwise degrade performance of the battery or device during operation. Electrical isolation materials include, but are not limited to, e.g., polytetrafluoroethylene (PTFE) (e.g., TEFLON®, DuPont, Wilmington, Del., USA), fluorinated ethylene propylene (FEP), perfluoroalkoxy polymer resin (PFA), insulating ceramics, insulating metals, silicones, other electrical isolation materials, including combinations of these various materials. In some embodiments, electrical isolation materials may be flowable or melt-processible to facilitate use. However, no limitations are intended. Secondary seal materials may include, but are not limited to, e.g., polytetrafluoroethylene (PTFE), epoxies, glasses, other sealing materials, including combinations of various seal materials.

Assembly of compliant polymer seals, electrical isolation materials, and secondary seal materials in the energy storage device may be performed with methods known in the fabrication arts including, but not limited to, e.g., screen printing, injection molding, screw extrusion, imprinting, casting, sectioning, shearing, positioning, inserting, blowing, depositing, and other application processes. No limitations are intended.

Compliant polymer seals of the present invention are configured to seal sodium-conducting energy storage devices and batteries at operation temperatures selected between about 100° C. to about 250° C. In some embodiments, compliant seals seal the battery at an operation temperature between about 100° C. to about 200° C. that enhances the cycling lifetime by suppressing temperature related degradation and temperature related corrosion of the compliant polymer seals. In some embodiments, compliant seals seal the battery at an operation temperature between about 180° C. to about 250° C. Operation at these reduced temperatures also allows low-cost materials to be used for construction of elastomeric seals, sealants, and gaskets.

Compliant polymer seals of the present invention are configured to become viscous at the operation temperature which seals the battery or device during operation. Viscosity is also a function of molecular weights of the selected polymer. Viscosities are not limited. Molecular weights of the polymers are also not limited. Viscosity may thus be modified depending on the choice of polymer, molecular weight, addition of modifiers and fillers, and design of the seal. Molecular weights, and modifiers and fillers are not intended to be limited.

In some embodiments, compliant polymer seals may include one or more modifiers or fillers selected to increase or modify the viscosity of the native polymer in the assembled energy storage device during operation at the operation temperature. In some embodiments, viscosity of compliant polymer seals may be enhanced or increased so that compliant polymer seals may be compressed under a compressive load or with pressure during operation to ensure tight seals. Modifiers and fillers may be selected that are compatible with cathode and anode materials and electrolytes. Modifiers include, but are not limited to, e.g., glasses, polymers, epoxies, ceramics, metals, other modifiers, and combinations of various modifiers. Modifiers are not intended to be limited. In some embodiments, viscosity may be increased with addition of ceramics such as insulating ceramic powders including, e.g., alumina and yttrium-stabilized zirconia (YSZ). Concentrations of modifiers are also not limited. In various embodiments, modifiers in the compliant polymer seals may include a concentration up to about 50% by weight therein. All polymer selections, electrical isolation materials, secondary sealing materials, modifiers and fillers, and other materials as will be contemplated by those of ordinary skill in the art in view of the disclosure for use in the energy storage device are within the scope of the present invention. No limitations are intended.

Compliant polymer seals of the present invention also allow sealing of device components with different thermal expansion (or thermal expansion mismatch) values following assembly. Viscosities of the compliant polymer seals may be selected to accommodate thermal energy mismatches or thermal energy differences between different components in the assembled battery during operation.

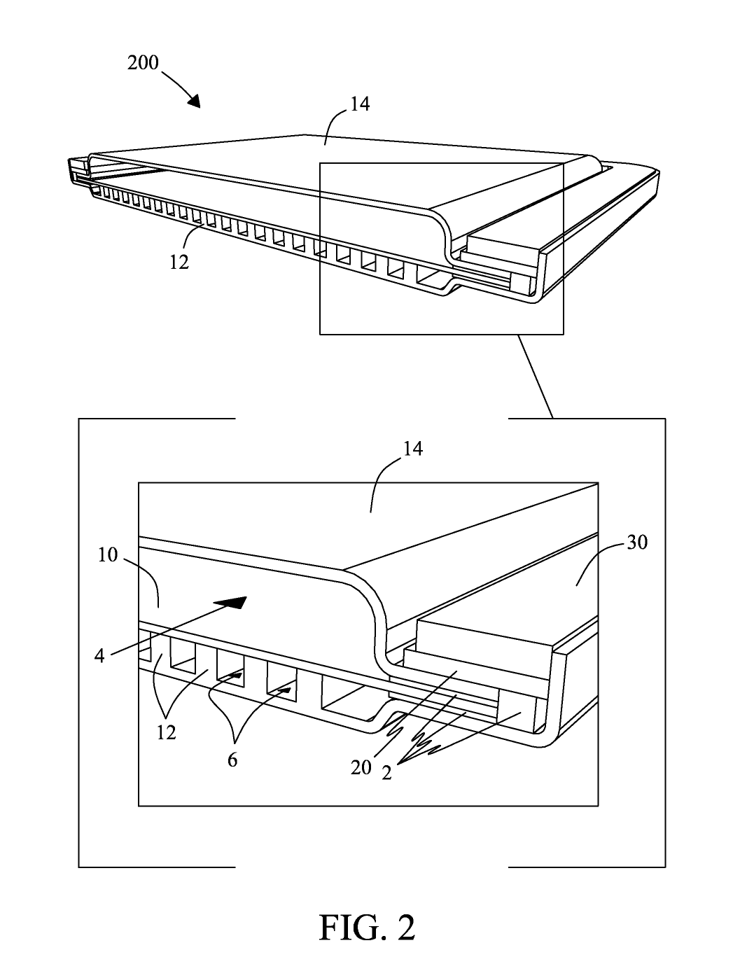

FIG. 2 shows an expanded view of another ZEBRA battery 200 of a planar cell design configured with compliant polymer seals 2 of the present invention. Active area of cell 200 is not limited. Battery 200 may include a cathode chamber 4 for containing a cathode (not shown) as a first half cell of the battery, and an anode chamber 6 for containing an anode (not shown) as a second half cell of the battery. A β″-alumina solid electrolyte (BASE) 10 is shown positioned between cathode chamber 4 and anode chamber 6 that delivers sodium ions (Na⁺) between the cathode and anode during operation. Sodium metal formed at the surface of BASE 10 may be accumulated in anode shims 12 positioned within anode chamber 6. Cathode chamber 4 and anode chamber 6 may each be enclosed within a canister enclosure (or can) 14 constructed of a selected metal, metal alloy, ceramic, or other suitable material. A retaining ring 30 may be employed to secure cathode and anode enclosures 14 together for operation once cell components are assembled.

Compliant polymer seals 2 of the present invention may be positioned at selected locations to seal battery 200, e.g., oriented horizontally at an end between cathode enclosure 14 and BASE 10 on the cathode side of BASE 10 and at an end between anode enclosure 14 and BASE 10 on the anode side of BASE 10. Compliant polymer seals 2 may also be positioned, e.g., at respective ends of BASE 10 below retaining ring 30 to enclose BASE 10 and seal cathode chamber 4 and anode chamber 6.

As shown in the figure, a secondary material 20 such as an electrical insulation or isolator material or a secondary sealing material may be installed in battery 200 in concert with compliant seals 2, e.g., above cathode enclosure (can) 14 below retaining ring 30 to provide additional properties to the device. As discussed previously, secondary material 20 may include an electrical (isolator) insulation material to provide electrical separation between cathode chamber 4 and anode chamber 6 or a secondary sealing material to minimize diffusion of oxygen and other oxidative gases, or penetration by aggressive chemical electrolytes and chemical components that can degrade performance of the compliant polymer seals and the battery during operation. No limitations are intended. All secondary materials as will be selected by those of ordinary skill in the art in view of the description are within the scope of the present invention.

In some embodiments, compliant seals of the present invention may be encapsulated in various materials prior to assembly in the energy storage device to improve sealing properties and to accommodate thermal expansion mismatches between components in the battery during operation. Materials suitable for encapsulating compliant polymer seals include, but are not limited to, e.g., polytetrafluoroethylene (PTFE), polyethylene polymers, plastics, epoxies, glasses, ceramics, metals, silicones, and combinations of these materials that assist the sealing of assembled battery components.

Compliant seals 2 may be introduced or assembled into energy storage devices 100 or 200 with the devices in a discharged or unenergized state prior to operation. This capability is advantageous and fills an unmet need in the art for some sodium-conducting energy storage devices (e.g., Na—S batteries) in which fabrication of seals can only be performed with the device in the energized state.

### Performance in Operation

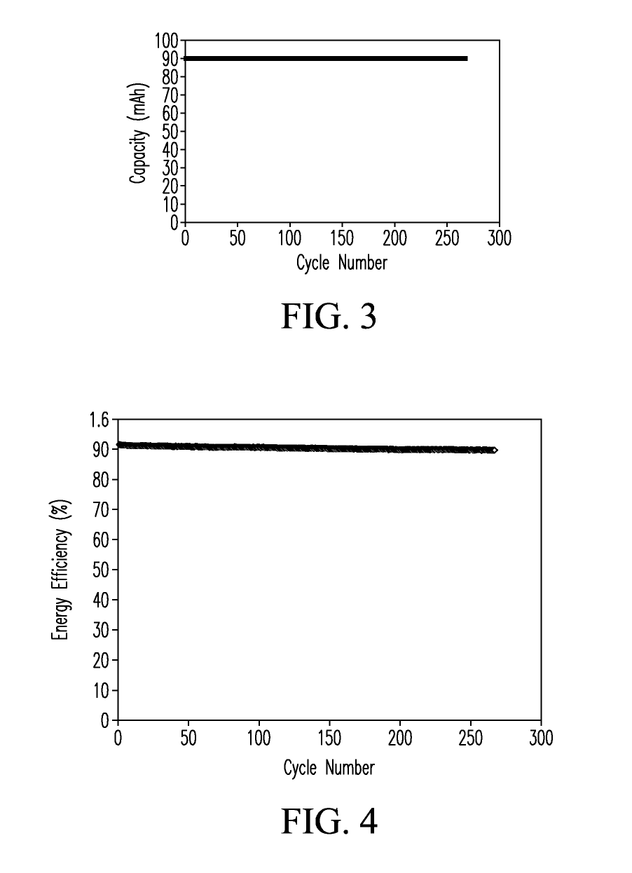

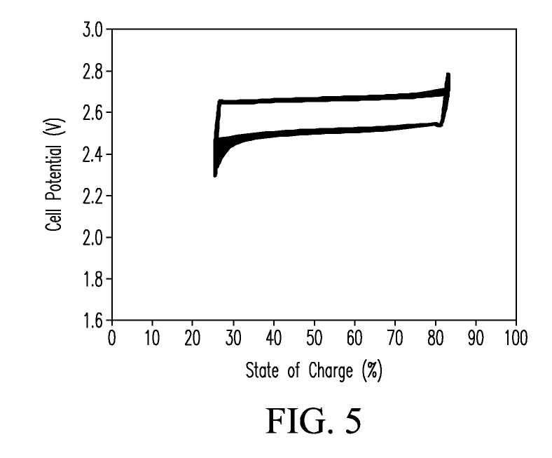

Compliant seals of the present invention decrease performance degradation in sodium-conducting energy storage devices during operation at temperature over time. Performance degradation of the energy storage devices may be assessed by performance measures including, but not limited to, e.g., capacity, energy efficiency, potential, state-of-charge (SoC), and combinations of these various measures. FIG. 3 plots capacity [in milliamp hours (mAh)] of the ZEBRA battery of FIG. 1 as a function of cycle number. Results show capacity remains steady over a cycle lifetime of at least 250 charge-discharge cycles at a power discharge rate of 25 milliwatts per square centimeter (mW/cm²) at the selected operation temperature. FIG. 4 plots energy efficiency (%) of the ZEBRA battery as a function of cycle number. Results show energy efficiency of the battery decreases less than about 5% over a cycle lifetime of at least 250 charge-discharge cycles at a power discharge rate of 25 milliwatts per square centimeter (mW/cm²) at the selected operation temperature. FIG. 5 plots cell potential (in Volts) of the ZEBRA battery as a function of SoC. Results show integrity of the cell potential remains intact as evidenced by an absence of hysteresis over a cycle lifetime of at least 250 charge-discharge cycles at a power discharge rate of 25 mW/cm² at the selected operation temperature. Results may be attributed to the longevity, resistance to corrosion, and sealing provided by the compliant polymer seals of the present invention and other sealing materials.

The present invention provides important benefits. Compliant polymer seals of the present invention permit energy storage devices to be operated at lower temperatures, which improve cycle lifetimes by reducing seal degradation. Compliant polymer seals can be constructed of low-cost materials that reduce costs of manufacturing energy device cells. Seals are easily applied to surfaces of components for assembly and sealing in the energy storage device so complex fabrication procedures are not required. In addition, anode and cathode chambers such as a-alpha alumina rings that typically require machining of high-temperature ceramics may be exchanged with simple structures that require little machining comparatively such as, e.g. metal enclosures (cases). And, complex sealing procedures including, e.g., in-situ high-temperature glass sealing may be exchanged with low-temperature encapsulation of individual components prior to assembly. Use of low-cost materials and ease of assembly into energy storage devices improves economics of manufacturing, e.g., permitting high throughput assembly and fabrication.

While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the present invention.

What is claimed is:

1. A process for sealing a sodium conducting energy storage device, the process comprising the step of:
introducing a compliant seal comprising a selected polymer at an interface or junction disposed between one or more selected components of the energy storage device that becomes viscous at an operation temperature at or below about 250° C., sealing the interface between the selected components to seal the device.

2. The process of claim 1, wherein the operation temperature is selected between about 100° C. to about 250° C.

3. The process of claim 1, wherein the compliant seal comprises a polyethylene polymer.

4. The process of claim 1, wherein the compliant seal seals the energy storage device at a temperature above the (T_{g}) value of the polymer.

5. The process of claim 1, wherein the compliant seal is introduced when the energy storage device is in the discharged or unenergized state prior to operation.

6. The process of claim 1, wherein the compliant seal is an encapsulated compliant seal encapsulated in a selected material.

7. The process of claim 1, wherein the compliant seal comprises a modifier that modifies the viscosity of the compliant seals above or below the viscosity of the native polymer during operation.

8. The process of claim 1, wherein the compliant seal is introduced between a support member and respective cathode and anode enclosures that define respective cathode and anode chambers of the energy storage device.

9. The process of claim 1, wherein a compliant polymer seal is introduced between a cathode chamber and an anode chamber on respective sides of a sodium-conducting solid electrolyte.

10. A compliant polymer seal for sealing a sodium-conducting energy storage device, the seal comprising:
a polymer of a selected material that becomes viscous at an operation temperature at or below about 250° C. configured to seal selected locations that seals the sodium-conducting energy storage device.

11. The compliant seal of claim 10, wherein the polymer is a polyethylene polymer.

12. The compliant seal of claim 10, wherein the polymer is configured to become viscous in the energy storage device at an operation temperature selected between about 100° C. to about 250° C. that seals same.

13. The compliant seal of claim 10, wherein the polymer of the compliant seal that seals the energy storage device becomes viscous at a temperature above the (T_{g}) value of the polymer.

14. The compliant seal of claim 10, wherein the compliant seal is an encapsulated compliant seal encapsulated in a selected material.

15. The compliant seal of claim 10, wherein the compliant seal comprises a modifier that modifies the viscosity of the compliant seals above or below the viscosity of the native polymer during operation.
